(19) United States
(12) Patent Application Publication
(10) Pub. No.: US 2025/0253562 A1
(43) Pub. Date: Aug. 7, 2025

(54) CABLE-END CONNECTOR AND COMBINATION OF CABLE-END CONNECTOR AND BOARD-END CONNECTOR

(71) Applicant: Molex, LLC, Lisle, IL (US)

(72) Inventor: Yi-Tse Ho, New Taipei City (TW)

(21) Appl. No.: 19/012,947

(22) Filed: Jan. 8, 2025

(30) Foreign Application Priority Data
Feb. 7, 2024 (CN) 202410174789.6

(51) Int. Cl. H01R 12/75; H01R 12/70

(52) U.S. Cl. CPC H01R 12/75; H01R 12/7005

(57) ABSTRACT

A combination of a cable-end connector and a board-end connector is provided. The cable-end connector includes an outer shell, a first terminal assembly and a second terminal assembly. The outer shell has a mating face which is toward a first direction. The first terminal assembly is provided in the outer shell, the first terminal assembly includes a first contacting member, a first conductive plate and a plurality of first electrical cables. The first contacting member extends toward the mating face. The first conductive plate connects the first contacting member and faces the first direction. The plurality of first electrical cables are arranged side by side along a second direction perpendicular to the first direction and connect the first conductive plate. The second terminal assembly is provided in the outer shell, the second terminal assembly includes a second contacting member, a second conductive plate and a plurality of second electrical cables. The second contacting member extends toward the mating face and extends staggeringly with the first contacting member. The second conductive plate connects the second contacting member and faces the first direction, the second conductive plate and the first conductive plate are arranged along the first direction. The plurality of second electrical cables are arranged side by side along the second direction and connect the second conductive plate.

### TECHNICAL FIELD

The present disclosure relates to a cable-end connector, and specifically relates to a cable-end connector and a combination of the cable-end connector and a board-end connector.

### BACKGROUND

Chinese patent document CN216850571U discloses a cable connector and a cable connector assembly, the cable connector is capable of mating with a mating connector in an up-down direction (i.e., a mating direction). The cable connector includes a plastic housing which has a receiving cavity, metal connecting members which each have an internal cavity, conductive terminals, cables and a locking release mechanism. The cables are two groups, the two groups of cables are provided to be arranged side by side in a left-right direction, each group of cables extend in a front-rear direction. The metal connecting members are two and respectively connect with the two groups of cables, where the cable number of each group of cable is two and the two cables are arranged side by side in the up-down direction.

However, in each group of cable, a maximum current value which can be carried by each cable is a fixed value according to a diameter of the cable, so the cable number of each group of cable should increase as more as possible in high current application, but using the above patent document, that the cables are arranged side by side in the up-down direction will increase a height of the cable connector in the up-down direction, and in turn increase the entire dimension and volume of the cable connector. In other words, the above patent document is difficult to attain design requirement on high current, lower height and miniaturization at the same time.

### SUMMARY

Therefore, an object of the present disclosure is to provide a cable-end connector and a combination of the cable-end connector and a board-end connector which can improve at least one problem in the prior art.

Accordingly, in some embodiments, a cable-end connector of the present disclosure comprises an outer shell, a first terminal assembly and a second terminal assembly. The outer shell has a mating face which is toward a first direction. The first terminal assembly is provided in the outer shell, the first terminal assembly comprises a first contacting member, a first conductive plate and a plurality of first electrical cables. The first contacting member extends toward the mating face. The first conductive plate connects the first contacting member and faces the first direction. The plurality of first electrical cables are arranged side by side along a second direction perpendicular to the first direction and connect the first conductive plate. The second terminal assembly is provided in the outer shell, the second terminal assembly comprises a second contacting member, a second conductive plate and a plurality of second electrical cables. The second contacting member extends toward the mating face and extends staggeringly with the first contacting member. The second conductive plate connects the second contacting member and faces the first direction, the second conductive plate and the first conductive plate are arranged along the first direction. The plurality of second electrical cables are arranged side by side along the second direction and connect the second conductive plate.

In some embodiments, the cable-end connector further comprises a first locking structure which is provided to the outer shell, the first locking structure, the first contacting member and the second contacting member is in a triangle arrangement.

In some embodiments, the outer shell has a first receiving groove and a second receiving groove, a depth of the first receiving groove is larger than a depth of the second receiving groove in the first direction, wherein the first terminal assembly is received in the first receiving groove, the second terminal assembly is received in the second receiving groove.

In some embodiments, the first terminal assembly and the second terminal assembly each are mounted to a pre-connecting position in the outer shell along the first direction, and each are mounted to a final-connecting position in the outer shell along a third direction perpendicular to the first direction and the second direction from the pre-connecting position, in the final-connecting position, the first terminal assembly and the second terminal assembly each are positioned in the first direction.

In some embodiments, the cable-end connector further comprises a first positioning member and a second positioning member; the first positioning member is used to be provided to the outer shell when the first terminal assembly is positioned in the final-connecting position, so as to make the first terminal assembly positioned in the third direction, the second positioning member is used to be provided to the outer shell when the second terminal assembly is positioned in the final-connecting position, so as to make the second terminal assembly positioned in the third direction.

In some embodiments, the first positioning member is a terminal positioning member which is provided in the outer shell, the second positioning member is a lid which is provided to the outer shell.

In some embodiments, the outer shell further has a first through groove and a second through groove which respectively receive the first contacting member and the second contacting member, the first through groove and the second through groove are staggered with each other, the first through groove extends from a bottom portion of the first receiving groove to the mating face, the second through groove extends from a bottom portion of the second receiving groove to the mating face.

In some embodiments, the first contacting member has a first mating portion and a first mounting portion, the second contacting member has a second mating portion and a second mounting portion, the first conductive plate has a first mounting hole which connects with the first mounting portion, the second conductive plate has a second mounting hole which connects with the second mounting portion.

In some embodiments, the plurality of the first electrical cables are welded to a plate surface of the first conductive plate with the plurality of the first electrical cables being arranged side by side along the second direction, the plurality of the second electrical cables are welded to a plate surface of the second conductive plate with the plurality of the second electrical cable being arranged side by side along the second direction.

In some embodiments, the outer shell further has a recessed portion, the first locking structure is at least partially positioned in the recessed portion.

Accordingly, in some embodiments, a combination of a cable-end connector and a board-end connector of the present disclosure comprises a cable-end connector and a board-end connector. The cable-end connector comprises an outer shell, a first terminal assembly and a second terminal assembly. The outer shell has a mating face which is toward a first direction. The first terminal assembly is provided in the outer shell, the first terminal assembly comprises a first contacting member, a first conductive plate and a plurality of first electrical cables. The first contacting member extends toward the mating face. The first conductive plate connects the first contacting member and faces the first direction. The plurality of first electrical cables are arranged side by side along a second direction perpendicular to the first direction and connect the first conductive plate. The second terminal assembly is provided in the outer shell, the second terminal assembly comprises a second contacting member, a second conductive plate and a plurality of second electrical cables. The second contacting member extends toward the mating face and extends staggeringly with the first contacting member. The second conductive plate connects the second contacting member and faces the first direction, the second conductive plate and the first conductive plate are arranged along the first direction. The plurality of second electrical cables are arranged side by side along the second direction and connect the second conductive plate. The board-end connector is used to mate with the cable-end connector, and the board-end connector comprises a substrate, a third contacting member and a fourth contacting member. The third contacting member is provided to the substrate and is used to be electrically connected with the first contacting member. The fourth contacting member is provided to the substrate and is used to be electrically connected with the second contacting member.

In some embodiments, the substrate is an insulative plate body, the board-end connector further comprises a circuit board, the third contacting member and the fourth contacting member respectively pass through the substrate and connect the circuit board.

In some embodiments, the board is a circuit board.

In some embodiments, the cable-end connector further comprises a first locking structure which is provided to the outer shell, the first locking structure, the first contacting member and the second contacting member is in a triangle arrangement, the board-end connector further comprises a second locking structure which is provided to the substrate, the second locking structure is used to lock with the first locking structure, the third contacting member, the fourth contacting member and the second locking structure is in a triangle arrangement.

In some embodiments, the outer shell has a recessed portion, the first locking structure is at least partially positioned in the recessed portion.

In the present disclosure, by the first conductive plate and the second conductive plate of the cable-end connector which are arranged along the first direction, and the plurality of first electrical cables and the plurality of second electrical cables which each are arranged side by side along the second direction, when the cable-end connector is in high current application, even if the number of the first electrical cables and the number of the second electrical cable are increased, a height of the cable-end connector in the first direction is not increased, and in turn the entire dimension and volume of the cable-end connector are controlled. In other words, the cable-end connector may attain design requirement on high current, lower height and miniaturization at the same time.

### BRIEF DESCRIPTION OF THE DRAWINGS

Other features and effects of the present disclosure will be apparent from embodiments with reference to the drawings, in which:

FIG. 1 is a perspective view of a first embodiment of a combination of a cable-end connector and a board-end connector of the present disclosure;

FIG. 2 to FIG. 4 are perspective exploded views of the first embodiment viewed from different angles;

FIG. 5 is a perspective exploded view of the cable-end connector of the embodiment;

FIG. 6 is a perspective exploded view of the cable-end connector of the embodiment viewed from another angle;

FIG. 7 is a perspective further exploded view of the cable-end connector of the embodiment of FIG. 5;

FIG. 8 to FIG. 14 are perspective schematic views for explaining assembling steps of the cable-end connector with an outer shell of the cable-end connector is partially cut away;

FIG. 15 is a perspective exploded view of a second embodiment of the combination of the cable-end connector and the board-end connector of the present disclosure; and

FIG. 16 is a perspective view of the cable-end connector in a third embodiment of the combination of the cable-end connector and the board-end connector of the present disclosure.

### DETAILED DESCRIPTION

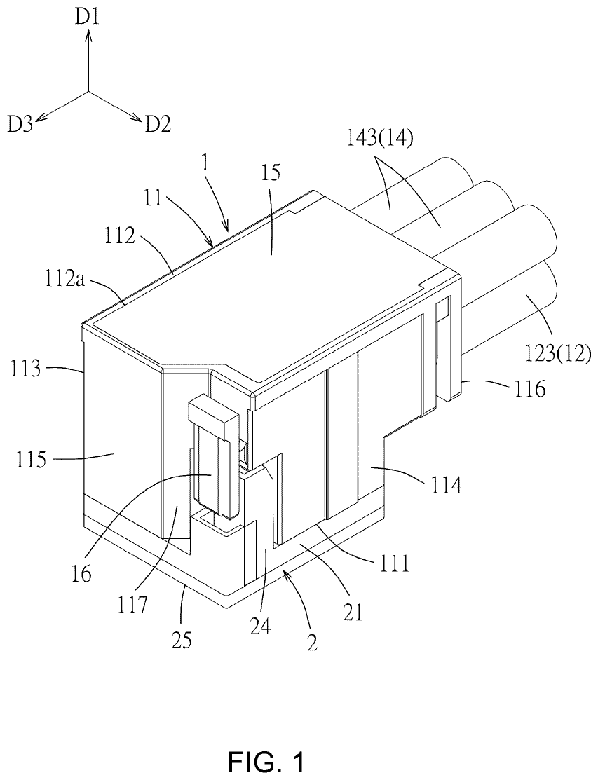

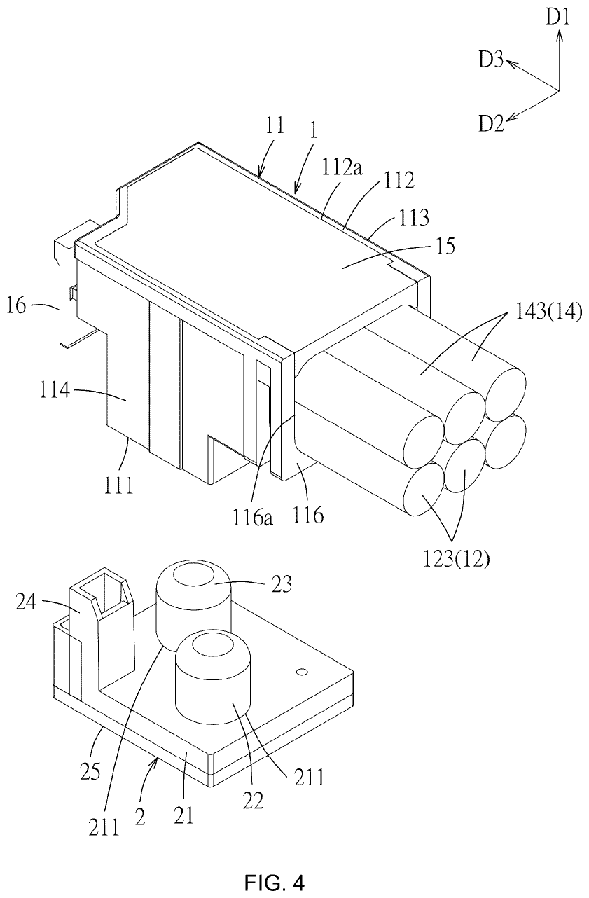

Referring to FIG. 1 to FIG. 4, a first embodiment of a combination of a cable-end connector 1 and a board-end connector 2 of the present disclosure includes a cable-end connector 1 and a board-end connector 2.

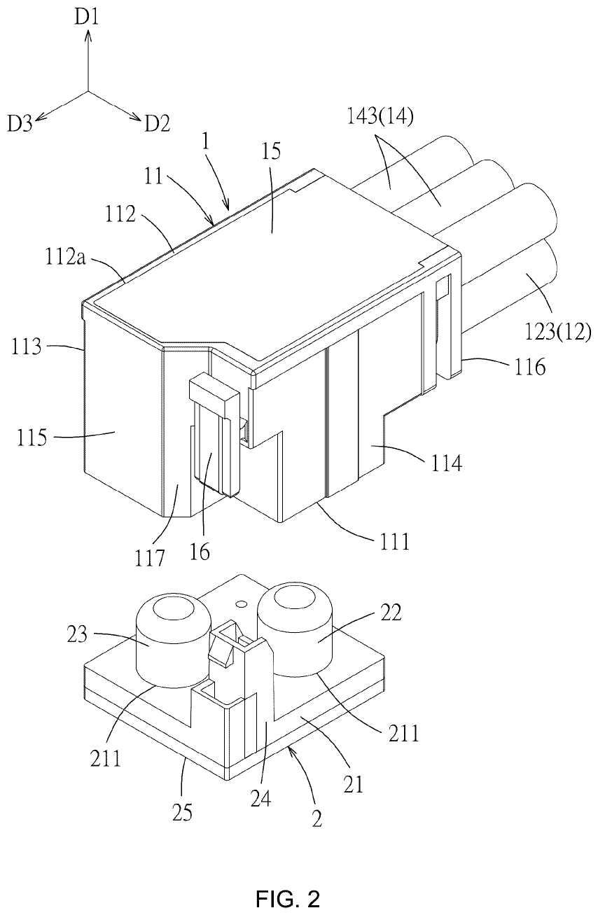

Referring to FIG. 2 to FIG. 6, the cable-end connector 1 includes an outer shell 11, a first terminal assembly 12, a first positioning member 13, a second terminal assembly 14, a second positioning member 15, and a first locking structure 16.

The outer shell 11 is an insulative material and has a mating face 111 and an upper end face 112 which are respectively positioned to a bottom portion and a top portion of the outer shell 11 along an up-down direction D1 (a first direction, a direction to which an arrow points is up and an opposite direction is down), are spaced apart from each other and face each other, a first side face 113 and a second side face 114 which face each other along a left-right direction D2 (a second direction, a direction to which an arrow points to is right and an opposite direction is left), a front end face 115 and a rear end face 116 which face each other along a front-rear direction D3 (a third direction, a direction to which an arrow points to is front and an opposite direction is rear), and a recessed portion 117 which is positioned to be adjacent to a corner between the front end face 115 and the second side face 114. Here, the mating face 111 in the first embodiment for example substantially is a rectangle defining the recessed portion 117.

And, the outer shell 11 further has a first receiving groove 118 and a second receiving groove 119 which are formed downwardly from the upper end face 112 along the up-down direction D1, two first protrusions 118a which are positioned to an inner wall face of the first receiving groove 118 and protrude inwardly along the left-right direction D2, two first passageways 118b which are positioned between the two first protrusions 118a and a bottom portion of the first receiving groove 118 respectively, a first position-limiting cavity 118c which is positioned to the inner wall face of the first receiving groove 118 at a front end of the first receiving groove 118, two first recesses 118d which are positioned to the inner wall face of the first receiving groove 118 and are recessed along the left-right direction D2, four second protrusions 119a which are positioned to an inner wall face of the second receiving groove 119 and protrude inwardly along the left-right direction D2, two second passageways 119b which are positioned between the two second protrusions 119a and a bottom portion of the second receiving groove 119 respectively, a second position-limiting cavity 119c which is positioned to the inner wall face of the second receiving groove 119 at a front end of the second receiving groove 119, four second recesses 119d which are positioned to the inner wall face of the second receiving groove 119 and are recessed along the left-right direction D2, a first through groove 118e which extends from the bottom portion of the first receiving groove 118 to the mating face 111, a second through groove 119e which extends from the bottom portion of the second receiving groove 119 to the mating face 111 and is staggered with the first through groove 118e, a top portion opening 112a which is positioned to the upper end face 112 and is communicated with the first receiving groove 118 and the second receiving groove 119, and a rear end opening 116a which is positioned to the rear end face 116 and is communicated with the first receiving groove 118 and the second receiving groove 119. In the up-down direction D1, a depth of the first receiving groove 118 is larger than a depth of the second receiving groove 119, specifically, the first receiving groove 118 is positioned below the second receiving groove 119. In addition, the recessed portion 117, the first through groove 118e and the second through groove 119e are in a triangle arrangement.

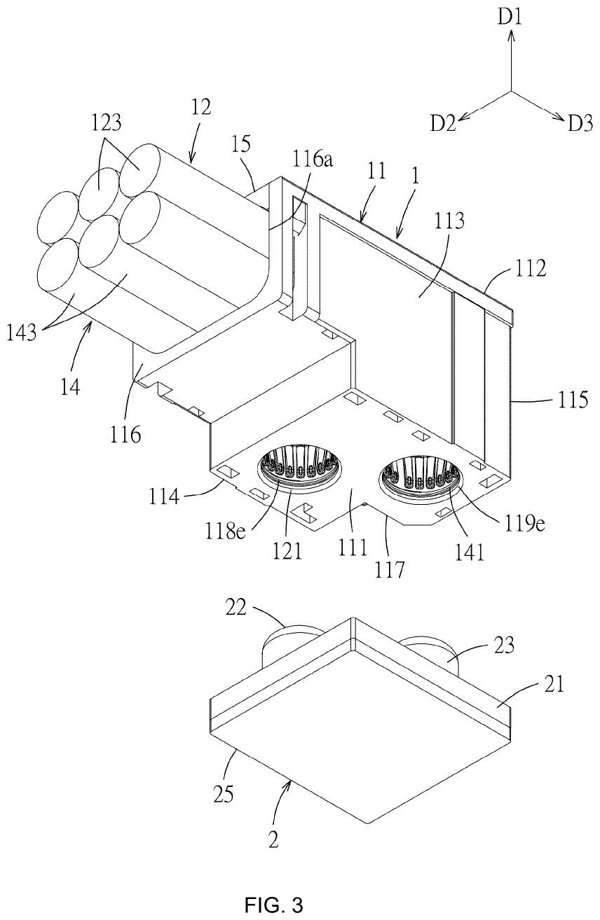

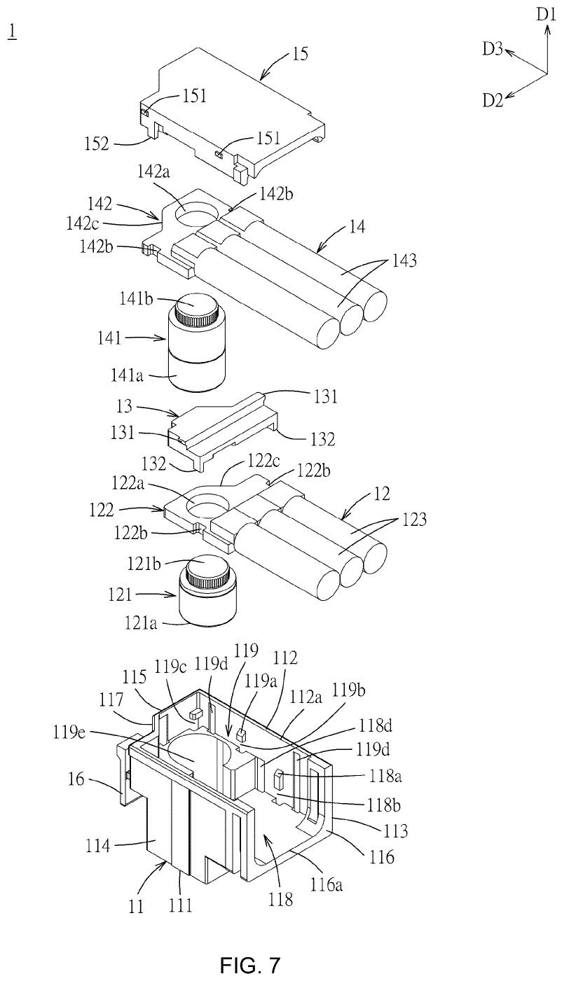

Referring to FIG. 3 to FIG. 7, the first terminal assembly 12 is provided in the outer shell 11, the first terminal assembly 12 includes a first contacting member 121, a first conductive plate 122, and a plurality of first electrical cables 123. The first contacting member 121 is received in the first through groove 118e of the outer shell 11, and the first contacting member 121 extends toward the mating face 111. The first contacting member 121 has a first mating portion 121a and a first mounting portion 121b.

The first conductive plate 122 of the first terminal assembly 12 connects the first contacting member 121 and is received in the first receiving groove 118 with the first conductive plate 122 facing the up-down direction D1. The first conductive plate 122 for example may be a metal plate or a circuit board. The first conductive plate 122 has a first mounting hole 122a which connects with the first mounting portion 121b, two first notches 122b which respectively correspond to two first protrusions 118a of the outer shell 11, and a first missed corner 122c which is used to avoid a part of the outer shell 11 which forms the second through groove 119e. It is noted that, in other implementing manners, the number of the first protrusion 118a and the number of the first notch 122b each also may be one or three or more, and may not limited to that of the first embodiment.

The plurality of first electrical cables 123 are arranged side by side along the left-right direction D2 and connect the first conductive plate 122 along a direction perpendicular to the left-right direction D2, and rearwardly pass out of the outer shell 11 via the rear end opening 116a, the plurality of first electrical cables 123 may be connected to a plate surface of the first conductive plate 122 by for example welding. Specifically, the number of the first electrical cables 123 is three in the first embodiment, but in other implementing manners may be two or four or more, preferably at least three or more, but the present disclosure is not limited thereto.

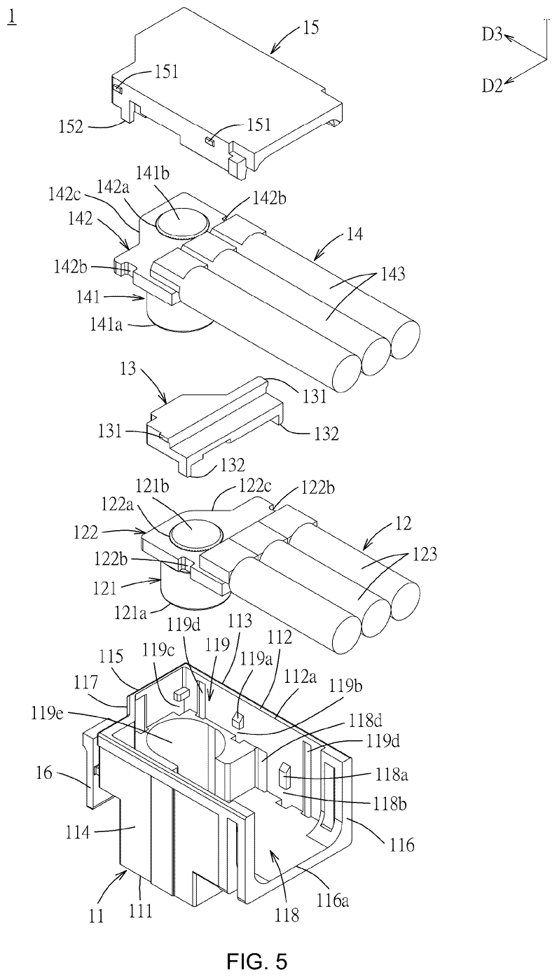

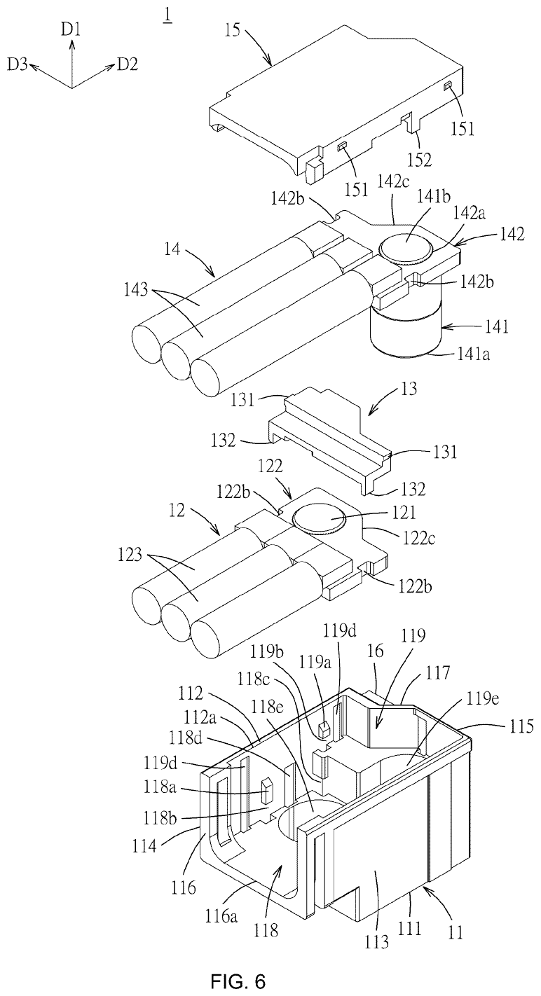

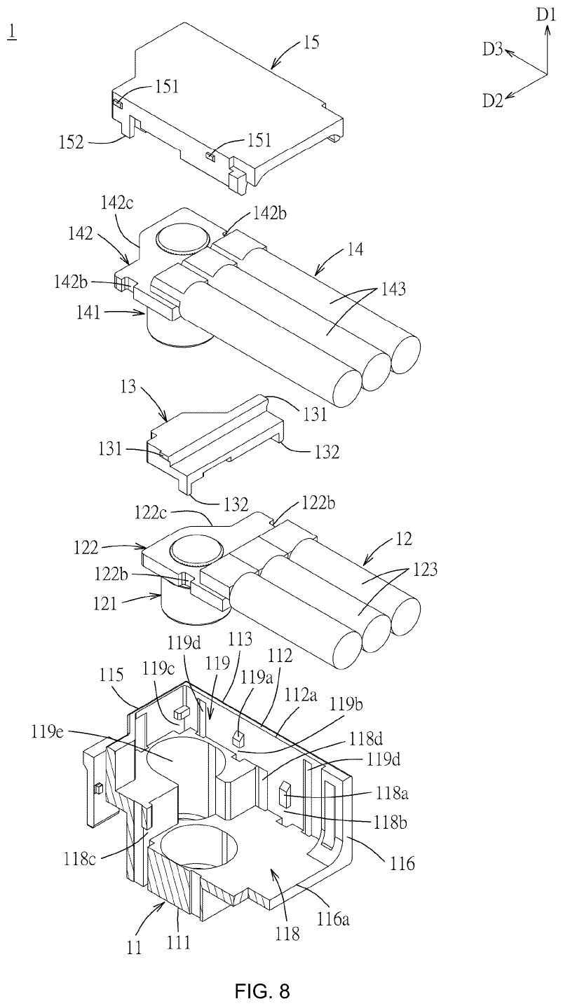

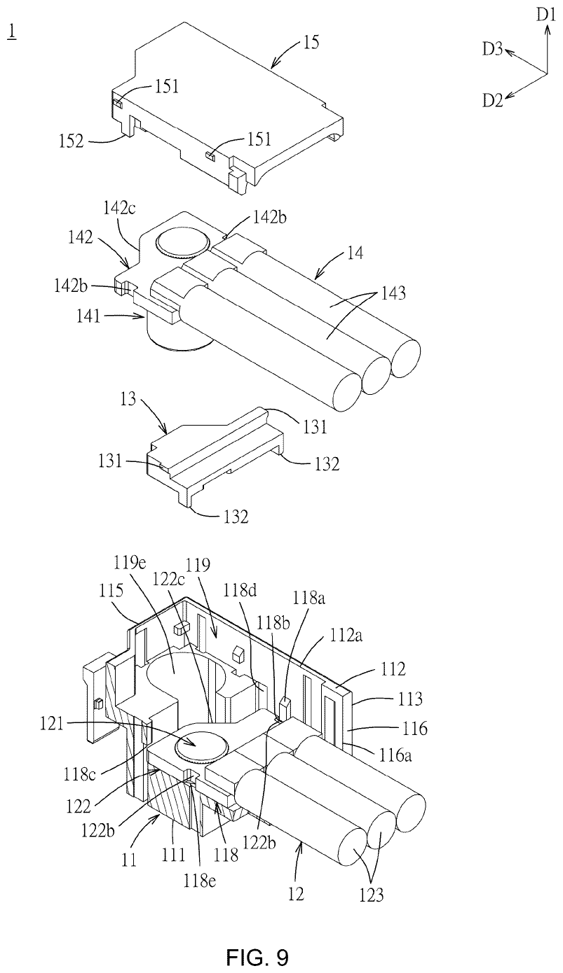

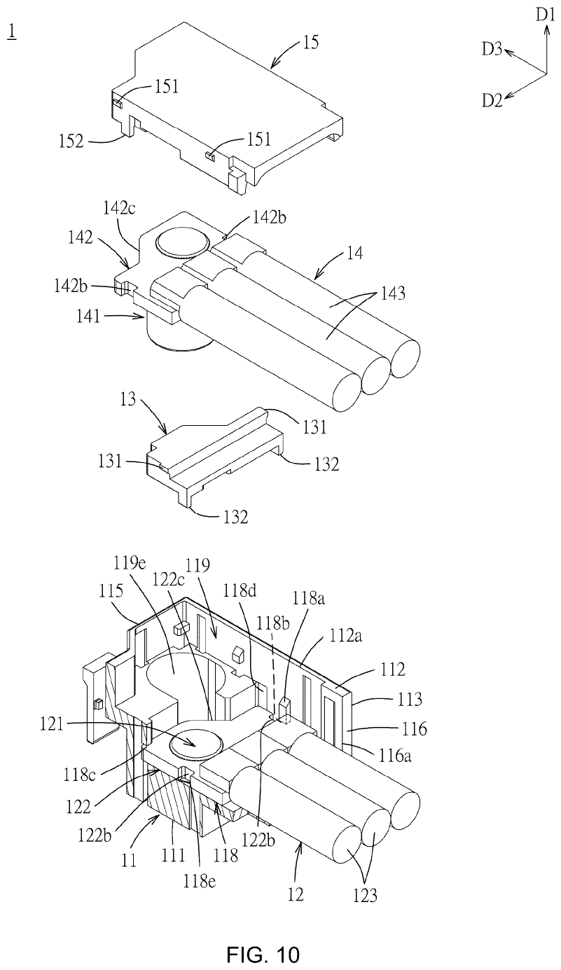

Referring to FIG. 5, FIG. 6 and FIG. 8 to FIG. 10, when the first terminal assembly 12 is assembled, the first terminal assembly 12 is downwardly mounted to a pre-connecting position in the first receiving groove 118 of the outer shell 11 along the up-down direction D1 via the top portion opening 112a, as shown in FIG. 9, in this process, the two first notches 122b of the first conductive plate 122 downwardly pass through the two first protrusions 118a, which are positioned to the inner wall face of the first receiving groove 118, along the up-down direction D1, to make the two first notches 122b respectively positioned in the two first passageways 118b which are between the two first protrusions 118a and the bottom portion of the first receiving groove 118. Next, the first terminal assembly 12 is forwardly mounted to a final-connecting position in the first receiving groove 118 of the outer shell 11 from the pre-connecting position along the front-rear direction D3, as shown in FIG. 10, the two first notches 122b of the first conductive plate 122 move forwardly along the front-rear direction D3 to be staggered with the two first passageways 118b, and make plate edges of the first conductive plate 122 at two sides of the first conductive plate 122 in the left-right direction D2 respectively move into the two first passageways 118b, and at the same time a plate edge of the first conductive plate 122 at a front end of the first conductive plate 122 also moves into the first position-limiting cavity 118c, so as to make the first terminal assembly 12 positioned in the up-down direction D1.

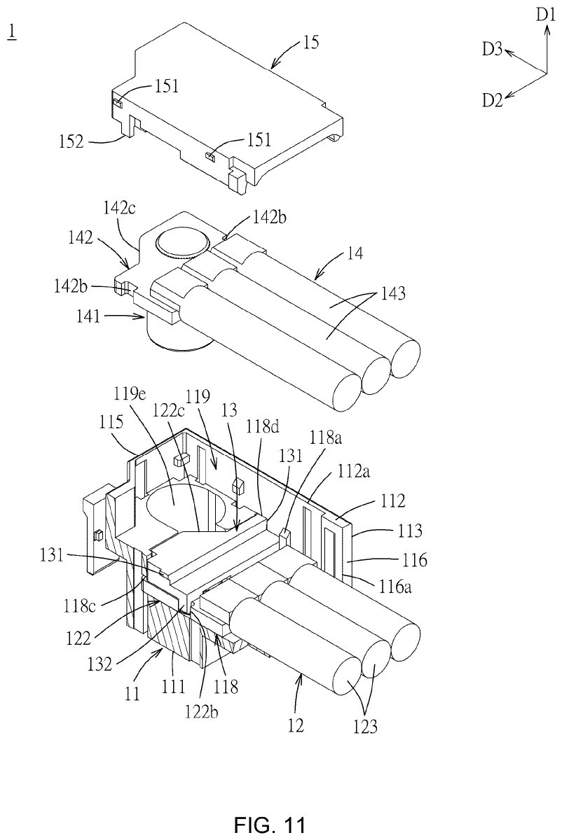

Referring to FIG. 5, FIG. 6 and FIG. 10 to FIG. 11, the first positioning member 13 is used to be provided to the outer shell 11 when the first terminal assembly 12 is positioned in the final-connecting position, so as to make the first terminal assembly 12 positioned in the front-rear direction D3. The first positioning member 13 is a terminal positioning member provided in the outer shell 11. The first positioning member 13 has two first protruding blocks 131 which respectively correspond to the two first recesses 118d of the outer shell 11 and two first positioning posts 132 which respectively correspond to the two first notches 122b. When the first terminal assembly 12 is positioned in the final-connecting position, the first positioning member 13 is used to be snapped into the outer shell 11, the two first protruding blocks 131 of the first positioning member 13 respectively snap into the two first recesses 118d, and the two first positioning posts 132 respectively downwardly insert into the two first notches 122b, as shown in FIG. 11, the two first positioning posts 132 make the first terminal assembly 12 positioned in the front-rear direction D3, in turn make the first terminal assembly 12 obtain complete assembling and fixing.

Referring to FIG. 3 to FIG. 7, the second terminal assembly 14 is provided in the outer shell 11. The second terminal assembly 14 includes a second contacting member 141, a second conductive plate 142, and a plurality of second electrical cables 143. The second contacting member 141 is received to the second through groove 119e of the outer shell 11, and the second contacting member 141 extends toward the mating face 111 and extends staggeringly with the first contacting member 121. The second contacting member 141 has a second mating portion 141a and a second mounting portion 141b.

The second conductive plate 142 of the second terminal assembly 14 connects the second contacting member 141 and is received in the second receiving groove 119 with the second conductive plate 142 facing the up-down direction D1, the second conductive plate 142 and the first conductive plate 122 are arranged along the up-down direction D1. The second conductive plate 142 for example may be a metal plate or a circuit board. The second conductive plate 142 has a second mounting hole 142a which connects with the second mounting portion 141b, the two second notches 142b which respectively correspond to the two second protrusions 119a of the outer shell 11, and a second missed corner 142c which is used to avoid a part of the outer shell 11 which forms the recessed portion 117. It is noted that, in other implementing manners, the number of the second protrusion 119a and the number of the second notch 142b each also may one or three or more, and may not limited to that of the first embodiment.

A plurality of second electrical cables 143 are arranged side by side along the left-right direction D2 and connect the second conductive plate 142 along a direction perpendicular to the left-right direction D2, and rearwardly pass out of the outer shell 11 via the rear end opening 116a, the plurality of second electrical cables 143 may be connected to a plate surface of the second conductive plate 142 by for example welding. Specifically, the number of the second electrical cable 143 is three in the first embodiment, but in other implementing manner may be two or four or more, preferably at least three or more, but the present disclosure is not limited thereto.

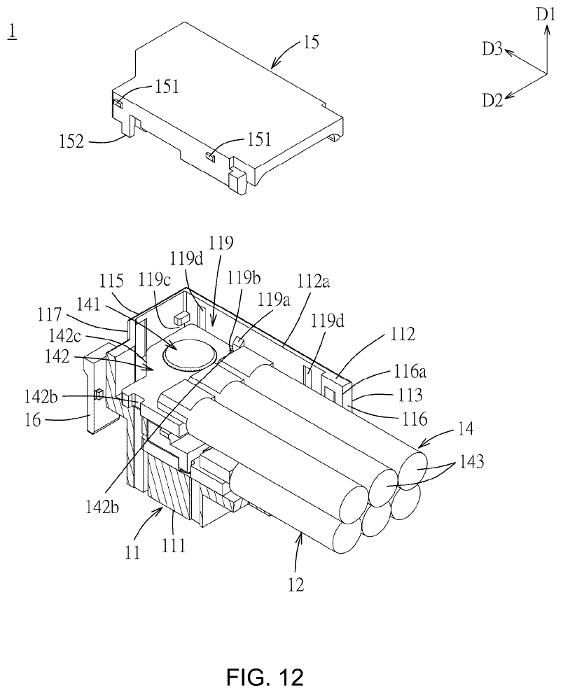

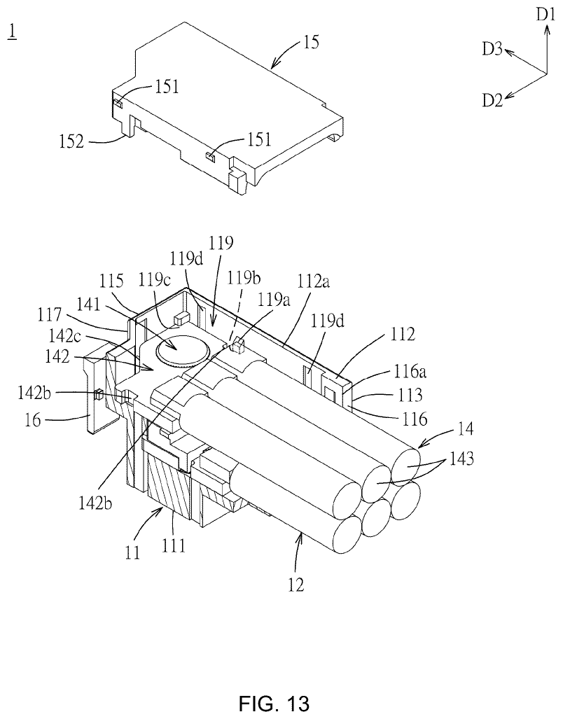

Referring to FIG. 5, FIG. 6 and FIG. 11 to FIG. 13, when the second terminal assembly 14 is assembled, the second terminal assembly 14 is downwardly mounted to a pre-connecting position in the second receiving groove 119 of the outer shell 11 along the up-down direction D1 via the top portion opening 112a, as shown in FIG. 12, in this process, the two second notches 142b of the second conductive plate 142 downwardly pass through the two second protrusions 119a, which are positioned to the inner wall face of the second receiving groove 119, along the up-down direction D1, to make the two second notches 142b respectively positioned in the two second passageways 119b which are between the two second protrusions 119a and the bottom portion of the second receiving groove 119. Next, the second terminal assembly 14 is forwardly mounted to a final-connecting position in the second receiving groove 119 of the outer shell 11 from the pre-connecting position along the front-rear direction D3, as shown in FIG. 13, the two second notches 142b of the second conductive plate 142 move forwardly along the front-rear direction D3 to be staggered with the two second passageways 119b, and make plate edges of the second conductive plate 142 at two sides of the second conductive plate 142 in the left-right direction D2 respectively move into the two second passageways 119b, and at the same time a plate edge of the second conductive plate 142 at a front end of the second conductive plate 142 also moves into the second position-limiting cavity 119c, so as to make the second terminal assembly 14 positioned in the up-down direction D1.

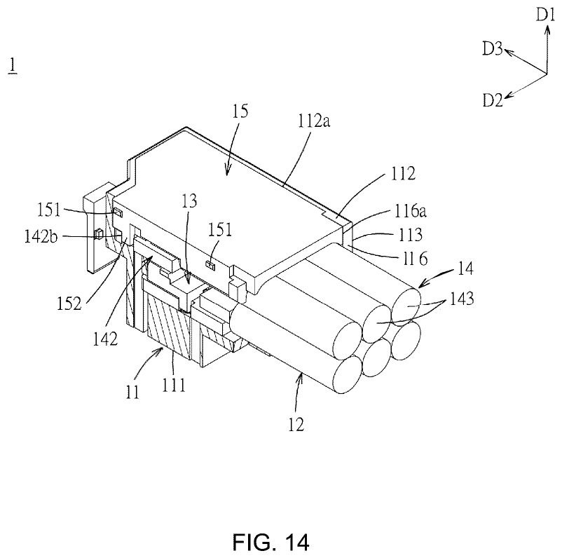

Referring to FIG. 5, FIG. 6 and FIG. 13 to FIG. 14, the second positioning member 15 is used to be provided to the outer shell 11 when the second terminal assembly 14 is positioned in the final-connecting position, so as to make the second terminal assembly 14 positioned in the front-rear direction D3. The second positioning member 15 is a lid which is provided to the outer shell 11 and closes the top portion opening 112a of the outer shell 11. The second positioning member 15 has four second protruding blocks 151 which respectively correspond to the four second recesses 119d of the outer shell 11 and two second positioning posts 152 which respectively correspond to the two second notches 142b. When the second terminal assembly 14 is positioned in the final-connecting position, the second positioning member 15 is used to snap into the outer shell 11 to close the top portion opening 112a of the outer shell 11, the four second protruding blocks 151 of the second positioning member 15 respectively snap into the four second recesses 119d, and the two second positioning posts 152 respectively downwardly insert into the two second notches 142b, as shown in FIG. 14, the two second positioning posts 152 make the second terminal assembly 14 positioned in the front-rear direction D3, in turn make the second terminal assembly 14 obtain complete assembling and fixing.

Referring to FIG. 1 and FIG. 2, the first locking structure 16 is provided to the outer shell 11, and is formed to be integrally constructed from the outer shell 11 and is positioned in the recessed portion 117, so as to make the recessed portion 117 (or the first locking structure 16 positioned to the recessed portion 117), the first contacting member 121 which is provided to the first through groove 118e, and the second contacting member 141 which is provided to the second through groove 119e, are in a triangle arrangement. It is noted that, in other implementing manner, the first locking structure 16 also may be only at least partially positioned in the recessed portion 117, and the first locking structure 16 also may be assembled to the outer shell 11 in a manner that the first locking structure 16 is assembled as an independent component, so the present disclosure is not limited to the first embodiment.

Referring to FIG. 1 to FIG. 4, the board-end connector 2 is used to mate with the cable-end connector 1 along the up-down direction D1, and the board-end connector 2 includes a substrate 21, a third contacting member 22, a fourth contacting member 23, a second locking structure 24, and a circuit board 25.

The third contacting member 22 is provided to the substrate 21 and is used to be electrically connected with the first contacting member 121. The fourth contacting member 23 is provided to the substrate 21 and is used to be electrically connected with the second contacting member 141. The second locking structure 24 is provided to the substrate 21 as integrally constructed with the substrate 21, and the second locking structure 24 is used to lock with the first locking structure 16. The third contacting member 22, the fourth contacting member 23 and the second locking structure 24 are in a triangle arrangement. It is noted that, in other implementing manner, the second locking structure 24 also may be assembled to the substrate 21 in a manner that the second locking structure 24 is assembled as an independent component, so the present disclosure is not limited to the first embodiment.

The substrate 21 of the board-end connector 2 is an insulative plate body. The circuit board 25 is provided below the substrate 21, the third contacting member 22 and the fourth contacting member 23 respectively downwardly pass through two penetrating holes 211 of the substrate 21 and connect the circuit board 25.

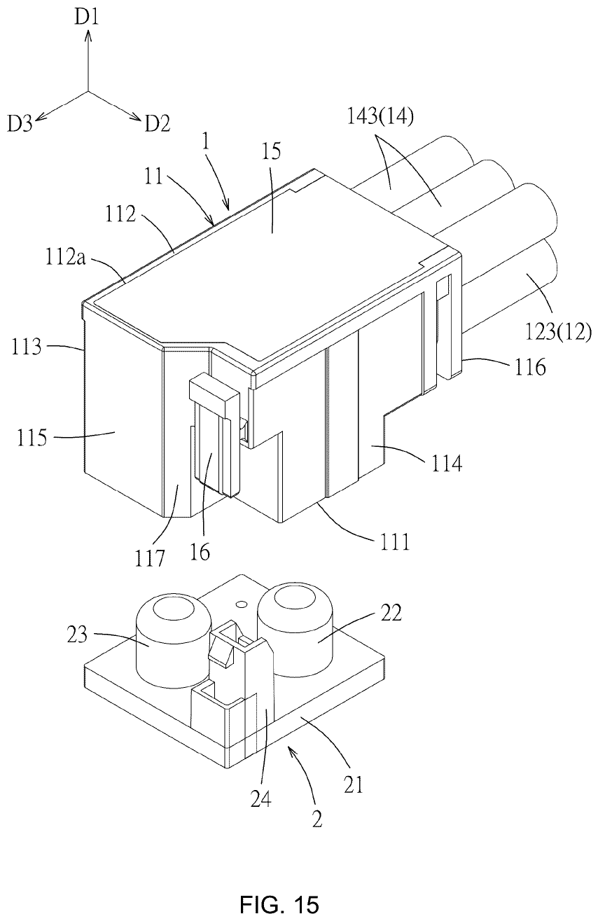

Referring to FIG. 15, difference of a second embodiment of the combination of the cable-end connector 1 and the board-end connector 2 of the present disclosure from the first embodiment lies in that, the substrate 21 of the board-end connector 2 is a circuit board. The second locking structure 24 is assembled to the substrate 21 in a manner that the second locking structure 24 is assembled as an independent component.

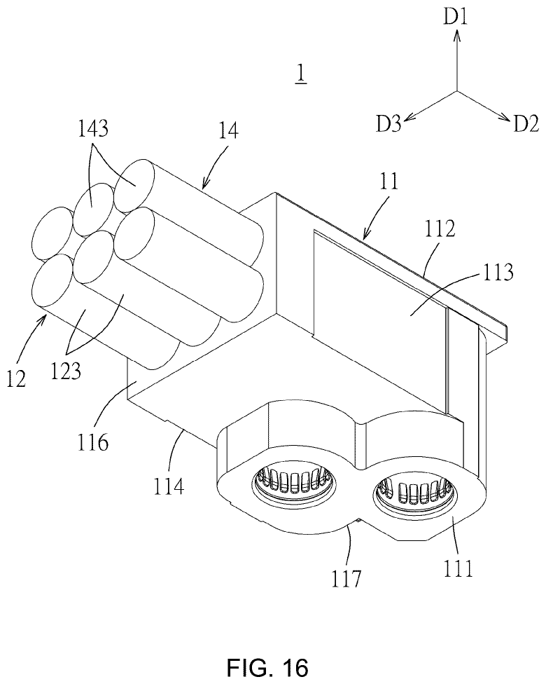

Referring to FIG. 16, difference of a third embodiment of the combination of the cable-end connector 1 and the board-end connector 2 of the present disclosure from the first embodiment lies in that, the mating face 111 of the cable-end connector 1 in the third embodiment substantially is a 8 digit shape which defines the recessed portion 117.

In conclusion, in the present disclosure, by the first conductive plate 122 and the second conductive plate 142 of the cable-end connector 1 which are arranged along the up-down direction D1 (the first direction), and the plurality of first electrical cables 123 and the plurality of second electrical cables 143 which each are arranged side by side along the left-right direction D2 (the second direction), when the cable-end connector 1 is in high current application, even if the number of the first electrical cables 123 and the number of the second electrical cable 143 are increased, a height of the cable-end connector 1 in the up-down direction D1 (the first direction) is not increased, and in turn the entire dimension and volume of the cable-end connector 1 are controlled. In other words, the cable-end connector 1 may attain design requirement on high current, lower height and miniaturization at the same time.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

What is claimed is:

1. A cable-end connector, comprising:
an outer shell having a mating face which is toward a first direction;
a first terminal assembly provided in the outer shell, the first terminal assembly comprising:
a first contacting member which extends toward the mating face,
a first conductive plate which connects the first contacting member and faces the first direction,
a plurality of first electrical cables which are arranged side by side along a second direction perpendicular to the first direction and connect the first conductive plate; and
a second terminal assembly provided in the outer shell, the second terminal assembly comprising:
a second contacting member which extends toward the mating face and extends staggeringly with the first contacting member,
a second conductive plate which connects the second contacting member and faces the first direction, the second conductive plate and the first conductive plate being arranged along the first direction,
a plurality of second electrical cables which are arranged side by side along the second direction and connect the second conductive plate.

2. The cable-end connector of claim 1, wherein
the cable-end connector further comprises a first locking structure which is provided to the outer shell, the first locking structure, the first contacting member and the second contacting member is in a triangle arrangement.

3. The cable-end connector of claim 1, wherein
the outer shell has a first receiving groove and a second receiving groove, a depth of the first receiving groove is larger than a depth of the second receiving groove in the first direction,
wherein the first terminal assembly is received in the first receiving groove, the second terminal assembly is received in the second receiving groove.

4. The cable-end connector of claim 1, wherein
the first terminal assembly and the second terminal assembly each are mounted to a pre-connecting position in the outer shell along the first direction, and each are mounted to a final-connecting position in the outer shell along a third direction perpendicular to the first direction and the second direction from the pre-connecting position, in the final-connecting position, the first terminal assembly and the second terminal assembly each are positioned in the first direction.

5. The cable-end connector of claim 4, wherein
the cable-end connector further comprises a first positioning member and a second positioning member;
the first positioning member is used to be provided to the outer shell when the first terminal assembly is positioned in the final-connecting position, so as to make the first terminal assembly positioned in the third direction,
the second positioning member is used to be provided to the outer shell when the second terminal assembly is positioned in the final-connecting position, so as to make the second terminal assembly positioned in the third direction.

6. The cable-end connector of claim 4, wherein
the first positioning member is a terminal positioning member which is provided in the outer shell,
the second positioning member is a lid which is provided to the outer shell.

7. The cable-end connector of claim 3, wherein
the outer shell further has a first through groove and a second through groove which respectively receive the first contacting member and the second contacting member,
the first through groove and the second through groove are staggered with each other,
the first through groove extends from a bottom portion of the first receiving groove to the mating face,
the second through groove extends from a bottom portion of the second receiving groove to the mating face.

8. The cable-end connector of claim 1, wherein
the first contacting member has a first mating portion and a first mounting portion,
the second contacting member has a second mating portion and a second mounting portion,
the first conductive plate has a first mounting hole which connects with the first mounting portion,
the second conductive plate has a second mounting hole which connects with the second mounting portion.

9. The cable-end connector of claim 1, wherein
the plurality of the first electrical cables are welded to a plate surface of the first conductive plate with the plurality of the first electrical cables being arranged side by side along the second direction,
the plurality of the second electrical cables are welded to a plate surface of the second conductive plate with the plurality of the second electrical cable being arranged side by side along the second direction.

10. The cable-end connector of claim 2, wherein
the outer shell further has a recessed portion,
the first locking structure is at least partially positioned in the recessed portion.

11. A combination of a cable-end connector and a board-end connector, comprising:
a cable-end connector comprising:
an outer shell having a mating face which is toward a first direction;
a first terminal assembly provided in the outer shell, the first terminal assembly comprising:
a first contacting member which extends toward the mating face,
a first conductive plate which connects the first contacting member and faces the first direction,
a plurality of first electrical cables which are arranged side by side along a second direction perpendicular to the first direction and connect the first conductive plate; and
a second terminal assembly provided in the outer shell, the second terminal assembly comprising:
a second contacting member which extends toward the mating face and extends staggeringly with the first contacting member,
a second conductive plate which connects the second contacting member and faces the first direction, the second conductive plate and the first conductive plate being arranged along the first direction,
a plurality of second electrical cables which are arranged side by side along the second direction and connect the second conductive plate; and
a board-end connector used to mate with the cable-end connector, and the board-end connector comprising:
a substrate;
a third contacting member which is provided to the substrate and is used to be electrically connected with the first contacting member;
a fourth contacting member which is provided to the substrate and is used to be electrically connected with the second contacting member.

12. The combination of the cable-end connector and the board-end connector of claim 11, wherein
the substrate is an insulative plate body,
the board-end connector further comprises a circuit board,
the third contacting member and the fourth contacting member respectively pass through
the substrate and connect the circuit board.

13. The combination of the cable-end connector and the board-end connector of claim 11, wherein
the board is a circuit board.

14. The combination of the cable-end connector and the board-end connector of claim 11, wherein
the cable-end connector further comprises a first locking structure which is provided to the outer shell, the first locking structure, the first contacting member and the second contacting member is in a triangle arrangement,
the board-end connector further comprises a second locking structure which is provided to the substrate, the second locking structure is used to lock with the first locking structure, the third contacting member, the fourth contacting member and the second locking structure is in a triangle arrangement.

15. The combination of the cable-end connector and the board-end connector of claim 14, wherein
the outer shell has a recessed portion,
the first locking structure is at least partially positioned in the recessed portion.
